(19) United States
(12) Patent Application Publication
(10) Pub. No.: US 2006/0266682 A1
(43) Pub. Date: Nov. 30, 2006

(54) Vessel and method for water treatment

(76) Inventors: Gary Andrew Kennedy, Croydon (AU); Raymond Albert Hin, Lilydale (AU); Peter Baden Farrer, Blackburn (AU)

Correspondence Address: JOHN S. PRATT, ESQ;KILPATRICK STOCKTON, LLP, 1100 PEACHTREE STREET, ATLANTA, GA, 30309, US

(21) Appl. No.: 11/402,362

(22) Filed: Apr. 12, 2006

Related U.S. Application Data
(60) Provisional application No. 60/670,383, filed on Apr. 12, 2005.

(51) Int. Cl. B01D 15/00

(52) U.S. Cl. 210/198.1

(57) ABSTRACT

This invention relates to a vessel suitable for insertion as a by-pass into new or pre-existing fluid flow paths, such as water lines for swimming pools. The vessel is adapted to receive and contain a wide variety of different types of equipment, which can typically be in the form of a cartridge, and contact the fluid passing through the vessel with the equipment in a way that reduces or minimizes the effect of pressure spikes in the water line, and more efficiently moves the water through the vessel and back into the fluid flow path or conduit. The invention also relates to a method for treating fluids using such a vessel.

This application claims priority to provisional application Ser. No. 60/670,383, filed Apr. 12, 2005, the entire contents of which are incorporated herein by reference.

### BACKGROUND OF THE INVENTION

1. Field of the Invention

The invention relates to a vessel suitable for installation in a water flow path that provides a chamber adapted to receive a cartridge for water purification, testing or other water treatment processing, while decreasing the effect of sudden pressure increases or pressure spikes in the water line. The vessel can be easily inserted in existing water flow paths in virtually any orientation. The decrease in the effect of pressure spikes reduces the wear and tear on equipment contained in the chamber, and allows the equipment and vessel to be made from less expensive materials and to increase their lifetime.

2. Description of Related Art

The field of fluid processing and treatment in general, and more particularly, of water treatment and monitoring, particularly pool water treatment and monitoring, is concerned with efficient removal, transport, processing/evaluation, and return of fluids to a reservoir thereof. In particular, in the pool water treatment area, water is typically removed from the pool and processed or evaluated for any number of reasons, but often for the purposes of (1) filtering and/or otherwise treating the pool water to make it safer for swimmers and bathers and to give the water a clean, sparkling appearance, and (2) monitoring the physical and/or chemical properties of the water to assess the efficacy and safety of the various methods used to treat the water.

This requires that the pool water be brought into contact with various forms of water treatment or monitoring equipment. This equipment can include media, often in the form of cartridges, through which the water flows in contact with the media. The contact between the water and the media introduces various sanitizing treatment chemicals, such as hypohalites or silver, anti-algal or antifungal metals, such as copper, or zinc, flocculants, such as lanthanides, and other chemical compounds, into the water.

Another form of equipment frequently contacted with pool water is the electrode assembly associated with a salt water chlorinator (SWC) or salt water brominator (SWB). This technique utilizes relatively low concentrations of saline or bromide salt in the pool water and subjects the halide ions therein to an electrolytic reaction which converts the chloride to hypohalite, helping to sanitize the water. SWC's and SWB's have found increasing acceptance as a method of maintaining pool water safety, as they are easy for the pool owner to use, do not require the handling or addition of potentially harmful or corrosive chemicals, do not result in large concentration gradients of hypohalite within the pool, and require less monitoring of pool chemistry than conventional addition of hypohalite.

Yet another form of equipment frequently encountered in pool systems is pool monitoring equipment, such as flowmeters, pH meters, conductivity meters, chlorine, bromine, or ORP sensors, or other sensors or probes and the like.

All of the equipment described can be piped in-line with a conduit removing water from the pool (or returning water back to the pool). However, such in-line plumbing (where all of the water in the conduit passes through the equipment, or the full flow passes by some element of the equipment as could be the case for sensors or probes, for example) can lead to equipment damage as pressure spikes, which arise due to inefficiencies in pumping, move through the conduits. These spikes must necessarily move through the equipment if the equipment is plumbed in-line.

One technique to decrease the effect of such pressure spikes is to plumb the equipment in a by-pass configuration, so that only part of the fluid flowing in the conduit passes through the equipment. Since the volume of water passing through the equipment is reduced, and since the fluid is forced to turn before entering the equipment, the effect of pressure spikes in the conduit is greatly reduced. One example of a device employing this principle is the Nature² Express® device available from Zodiac Pool Care.

However, there remains a need in the art for a vessel which is adapted to receive a large variety of different types of equipment, and which has improved flow within the vessel and improved means for returning fluid from the vessel to the conduit.

### SUMMARY OF THE INVENTION

The invention relates to a vessel suitable for insertion as a by-pass into new or pre-existing fluid flow paths, such as water lines for swimming pools. The vessel is adapted to receive and contain a wide variety of different types of equipment, which can typically be in the form of a cartridge, and contact the fluid passing through the vessel with the equipment in a way that reduces or minimizes the effect of pressure spikes in the water line, and more efficiently moves the water through the vessel and back into the fluid flow path or conduit. The invention also relates to a method for treating fluids using such a vessel.

The vessel contains an orifice divided into an inlet portion and an outlet portion. The inlet portion of the orifice is in fluid communication with a chamber within the vessel, wherein the chamber is adapted to contain equipment designed to treat or measure the fluid, e.g., an electrode for salt water chlorination, a cartridge containing water treatment media, a sensor probe for measuring chemical or physical properties of the fluid, and the like. The equipment is adapted to fit within the chamber such that fluid entering the chamber from the inlet also enters the relevant equipment inlet at a location near to where the vessel inlet communicates with the chamber, i.e., at the lower, proximal portion of the chamber.

The equipment is also adapted so that the fluid exiting the equipment leaves via the relevant equipment outlet located distally from the equipment inlet, i.e., reenters the chamber in an upper, distal region, which forms a subchamber or open space within the chamber. The fluid is then guided by a series of fins disposed between the distal upper and lower portions of the chamber, so that it flows along the lower portion of the chamber, outside the outer surface of the equipment, and exits the vessel through the outlet, from where it returns to the original fluid path.

In another embodiment, the invention relates to a method of decreasing the effects of sudden pressure increases in a fluid flow conduit on fluid processing or fluid measuring equipment, comprising:

diverting a fluid portion flowing in the fluid flow conduit to flow in a second direction approximately normal to the average direction of fluid flow in the conduit;

withdrawing the fluid portion from the conduit and directing it into a vessel;

diverting the flow direction of the fluid portion to a third direction substantially normal to the second direction;

directing the fluid portion into a chamber of the vessel comprising fluid processing or fluid measuring equipment

diverting the direction of fluid flowing in the chamber to a fourth direction substantially antiparallel to the third direction;

diverting the direction of fluid flowing out of the chamber to a fifth direction substantially antiparallel to the second direction; and

returning the fluid to the fluid flow conduit.

In another embodiment, the invention relates to a fluid processing vessel, comprising:

a chamber having a proximal region, a distal region, an upper region, and a lower region;

an inlet tube comprising an inlet opening, and an outlet opening disposed in, and in fluid communication with, the proximal lower region of the chamber;

an outlet tube comprising an inlet opening disposed in, and in fluid communication with, the proximal upper region of the chamber, and an outlet opening;

a fluid processing equipment space disposed in the distal region of the chamber. In this embodiment, fluid flowing in the conduit to which the vessel is attached is drawn into the inlet tube inlet opening, and exits the inlet tube outlet opening into the lower, proximal portion of the chamber. The fluid is drawn through the fluid processing space, first through the lower portion of that space, then back in the proximal direction, through the upper portion of that space until it reaches the inlet opening of the outlet tube, located in the proximal, upper portion of the chamber. It then enters the outlet tube, and is returned to the conduit through the outlet opening of the outlet tube.

In more particular embodiment, the invention relates to a fluid processing vessel, comprising:

a housing, attachable to a fluid flow conduit;

a clamp, adapted to secure the housing to a fluid flow conduit;

an inlet tube having at one end an inlet opening adapted to be in fluid communication with the fluid flow conduit and having an outlet opening at the other end, separated from the inlet opening by a length of the inlet tube;

a chamber disposed within the housing in fluid communication with the outlet opening of the inlet tube;

an outlet tube disposed distally adjacent and substantially parallel to the inlet tube, having an outlet opening at one end adapted to be in fluid communication with the fluid flow conduit, having an inlet opening at the other end in fluid communication with the chamber, separated from the outlet opening by a length longer than the length of the,inlet tube;

wherein the chamber extends distally from the inlet tube and outlet tube.

Positioning the vessel in a by-pass configuration causes only a portion of the fluid flowing in the fluid flow conduit enters the vessel through the orifice. This maintains the fluid flow conduit as the path of least resistance for water moving through the system under the influence of a pressure spike.

Because the design of the vessel reduces the effect within the vessel of pressure spikes in the water line, the risk of equipment damage from such pressure spikes is also reduced. This allows more sensitive equipment to be installed in fluid flow lines, whether the mechanism of the equipment is more delicate than had previously been thought possible to install, or whether the equipment can be made of less expensive, less structurally robust materials. In addition, because of its design, the vessel itself can be made of less robust, less expensive materials. The invention therefore provides for increased functionality in fluid treatment and/or monitoring, as well as for materials and design cost savings with respect to the equipment installed in the chamber.

In addition, by providing a single orifice with an inlet and outlet portion, only one opening in the fluid flow conduit is necessary to install the vessel. Fluid flow within the vessel is channeled and controlled so as to move the fluid more efficiently through the equipment and back into the fluid flow conduit, while at the same time causing the fluid to turn several times, which is believed to further limit the effect of pressure spikes on the vessel.

Additionally, the flow path of the vessel allows a wide variety of equipment to be installed therein, including equipment designed to have separate fluid inlets and outlets. Even though the fluid may flow into an equipment inlet, through the equipment, and out an equipment outlet, the vessel channels the flow so as to return it to the fluid flow conduit through the orifice.

### BRIEF DESCRIPTION OF DRAWINGS

FIG. 1 is a side perspective view of one embodiment of the vessel of the invention.

FIG. 2 is a side sectional view along line A-A of the embodiment shown in FIG. 1, and illustrating the flow path of the fluid in the vessel.

FIG. 3 is an exploded perspective view of the embodiment shown in FIG. 1 and FIG. 2.

FIG. 4 shows another embodiment of the device of the invention. FIG. 4A is a side view of this embodiment, while FIG. 4B, 4C, 4D, and 4E are front sectional views taken along section lines B-B, C-C, D-D, and E-E, respectively, in FIG. 4A.

FIG. 5 is a view of the embodiment of the vessel of FIG. 4. FIG. 5A is a front side perspective view; FIG. 5B is a rear side perspective view, and FIG. 5C is a rear lower perspective view; FIG. 5D is a front view, FIG. 5E is a top view, FIG. 5F is a bottom view, and FIG. 5G is a rear view of this embodiment.

FIG. 6 is a side sectional view of the embodiment of the invention shown in FIG. 4 and FIG. 5.

FIG. 7 is a side sectional view of the embodiment of the invention shown in FIG. 4, FIG. 5, and FIG. 6, showing a possible flow path through the vessel.

### DETAILED DESCRIPTION OF SPECIFIC EMBODIMENTS

The invention summarized above may be more clearly understood by reference to a specific embodiment thereof shown in the attached drawings. This description and the accompanying drawings are not meant to limit the scope of the invention in any way, but are merely illustrative of the embodiments that are included within the scope of the invention.

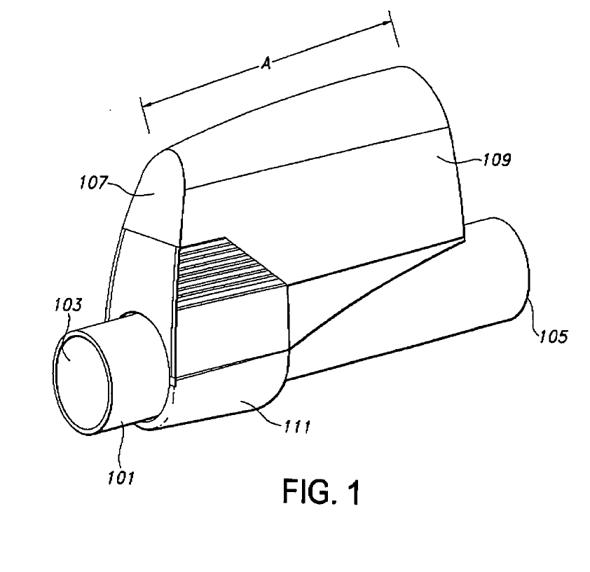

FIG. 1 shows an overall view one embodiment of the vessel of the invention in use. The vessel is attached to conduit 101, which does not itself form an element of the invention, but is included merely for the sake of clarity of explanation. Fluid, desirably water to be monitored or treated, flows in conduit 101 in the direction from area 103 to 105. Vessel 107 is rigidly attached to conduit 101 and held in place by clamp 111. Vessel 107 contains housing 109, which encloses the chamber described above.

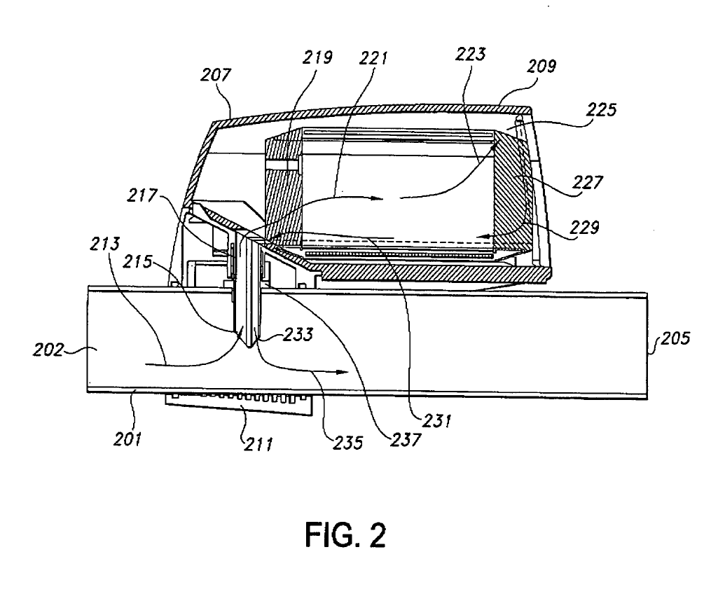

FIG. 2 shows a perspective sectional view of the vessel shown in FIG. 1 taken along line A-A of FIG. 1. Conduit 201 again is included for ease of understanding, and does not form an element of the invention. Fluid flows from area 203 of conduit 201 into inlet opening 215 of orifice 217 as indicated by flow arrow 213. Fluid then enters chamber 219 through the lower, proximal portion thereof, which is in fluid communication with inlet opening 215, as indicated by flow arrow 221. The fluid will then enter the equipment disposed in chamber 219 (not shown) through one or more appropriate equipment inlets, which are in fluid communication with the lower proximal portion of chamber 219. After passing through the equipment, fluid will exit the equipment through one or more appropriate equipment outlets, as indicated by flow arrow 223, and pass into subchamber 225, where it will be distributed across fins 227 extending from the upper portion of chamber 219 to the lower portion thereof. The fluid will flow along these fins, as indicated by flow arrow 229, and will then pass outside the equipment, along the lower portion of chamber 219, as indicated by flow arrow 231, which is in fluid communication with outlet opening 233 of orifice 217. As indicated by flow arrow 235, the fluid passes from outlet opening 233 back into conduit 201 and flows toward area 205.

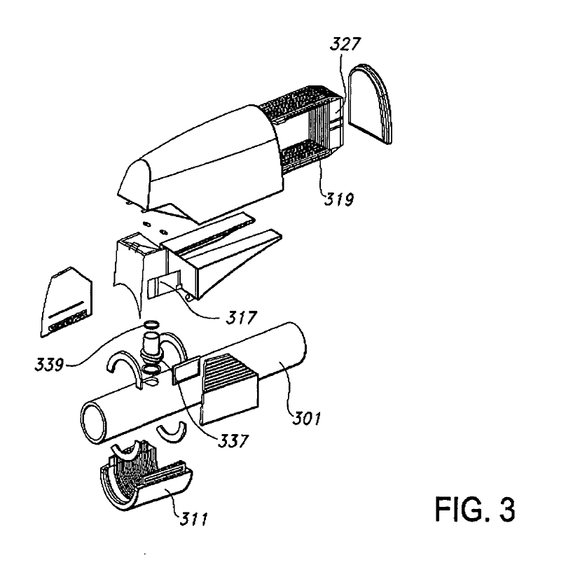

Vessel 207 is secured to conduit 201 by clamping device 211, which can be any suitable clamping mechanism for coupling the vessel to a cylindrical, rectangular, or other cross section conduit. A fluid-tight seal is provided by seal 237, which may be supplemented with O-rings 339 shown in FIG. 3 or other devices for preventing leakage.

Chamber 219 can be beneficially used to contain a wide variety of different types of fluid processing or fluid measurement equipment, including but not limited to fluid treatment media, such as cartridges containing, e.g., biocidal media for introducing metals or metal ions into the fluid as antibacterial, antifungal, antialgal, or other treatments, such as Nature²® available from Zodiac Pool Care; adsorbent media for removing contaminants from the fluid, such as activated carbon, zeolites, and the like; physicochemically functional species, such as clarifiers, flocculants, etc.; chemically functional species, such as enzymes, chelating agents, sequestrants, precipitants, and the like. The fluid processing equipment space can also contain electrode assemblies for use in electrolytic reactions, such as production of hypochlorite from chlorides in water; or chemical or physical measurement probes, such as flow, pH, conductivity, or temperature meters, and the like. The additives described above can be released into the fluid while it passes through the chamber, or can be bound to a substrate and retained in the chamber, so that their contact with the water is restricted to the chamber.

The description above of FIG. 2 can be more completely understood by reference to FIG. 3, which shows an exploded view of the elements of the device, such as clamp 311, seal 337, orifice 317, chamber 319, and fins 327.

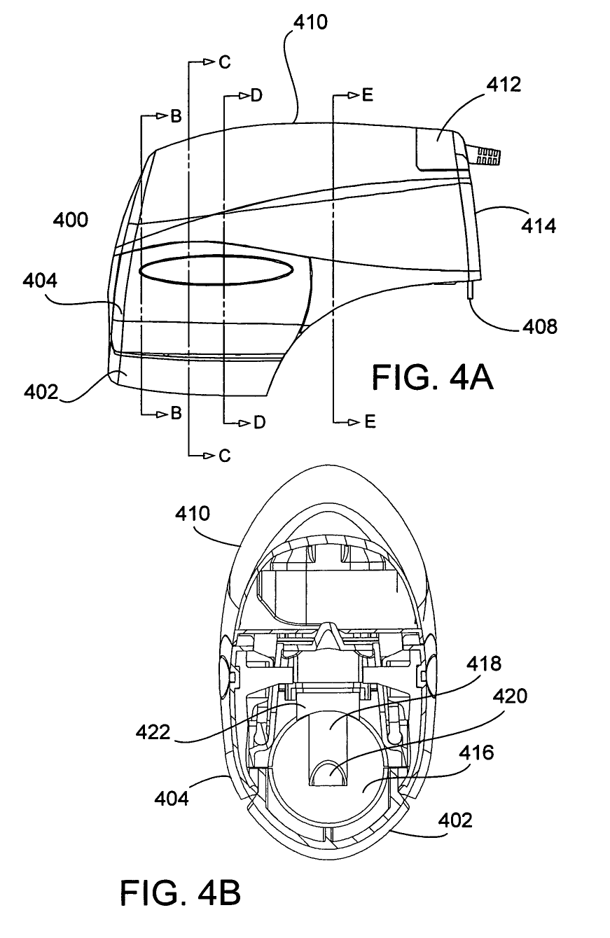

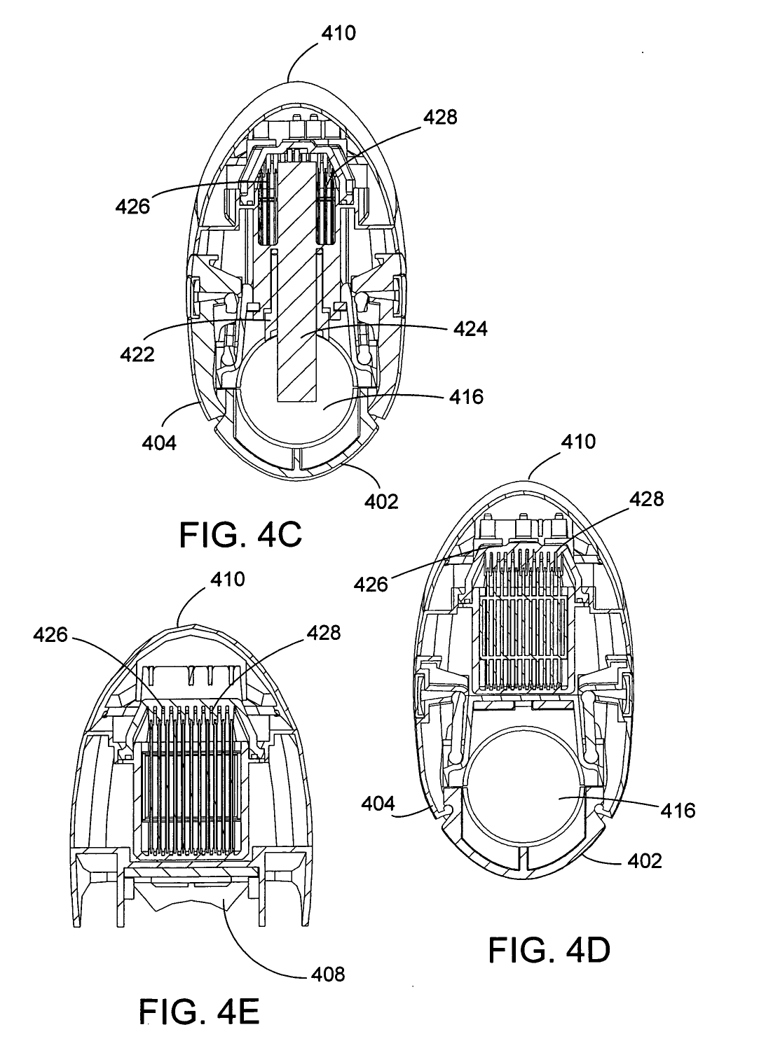

Another embodiment of the invention is shown in FIG. 4-7, as indicated above. As used herein, the terms “proximal” and “distal” refer to the location of a feature or direction toward or away from the front of the vessel, respectively. As used herein, the term “tube” means a conduit providing a confined flow path between the inlet and outlet thereof, and is not limited in cross sectional shape or configuration.

FIG. 4A shows a side view of this embodiment of the vessel, 400. The vessel contains a clamp 402 and a clamp plate 404 that serve to attach the vessel to a conduit (not shown) upon which rests a support 408. Disposed near the distal, upper portion of the housing 410 of the vessel is an electric power cable 412 which supplies electrical power to electrolytic cell 414. Electrolytic cell 414 as illustrated can be easily removed from the fluid processing equipment space and replaced by withdrawing support 408. Those of skill in the art will recognize that the illustrated embodiment relates to a vessel having an electrolytic cell disposed within the fluid processing equipment space of the vessel, but that the vessel could be readily modified to contain other, different equipment by replacement of the electrolytic cell and power cable with components suitable for other methods of water treatment or monitoring, consistent with the disclosed invention.

FIG. 4B shows a front cross sectional view taken along section line B-B of FIG. 4A. Clamp 402 and clamp plate 404 combine to define opening 416 which, in use, contains a conduit. Extending into opening 416 is inlet tube 418, which conveys fluid from the conduit through opening 420 into the proximal, lower portion of the interior chamber of the vessel. Inlet tube 418 is secured in place by tube adapter 422, which provides a leak proof seal with the conduit, preventing fluid from leaking from the joint between the conduit and the vessel. The tube adapter 422 allows for the leak-tight insertion of both inlet tube 418 and outlet tube 424 into a suitably sized opening that has been made in the surface of the conduit. Tube adapter 422 may include a rubber or polymeric O-ring, gasket, or other element typically used to provide a leak-tight seal with a conduit surface.

FIG. 4C shows a front cross sectional view taken along section line C-C of FIG. 4A. The front surface of outlet tube 424 extends between the proximal, upper portion of chamber 426 and opening for conduit 416. Outlet tube 424 functions to return fluid that has passed through the device to the conduit, and is located adjacent to and slightly distal to inlet tube 418. Within chamber 426 are visible the front end of electrode plates 428.

FIG. 4D shows a front cross sectional view taken along section line D-D of FIG. 4A, and provides an unobstructed view of chamber 426 and electrode plates 428. Those of skill in the art will recognize that electrode plates 428 can be replaced with other fluid measuring or treatment equipment in other embodiments of the invention.

FIG. 4E shows a front cross sectional view taken along section line E-E of FIG. 4A. Chamber 426 and electrode plates 428 are visible, as is support 408.

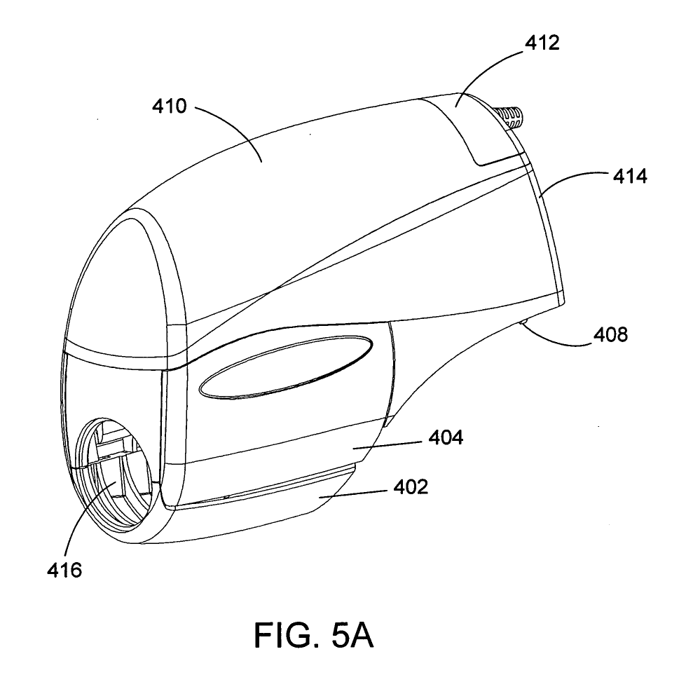

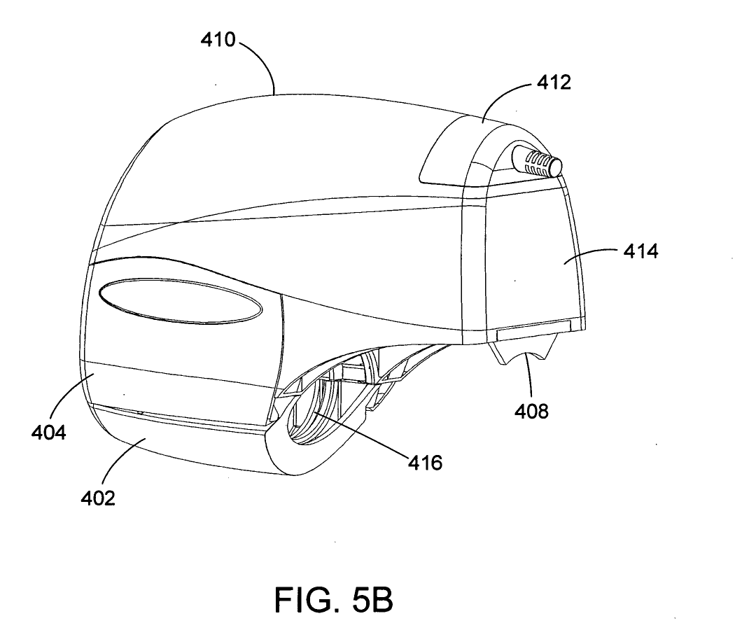

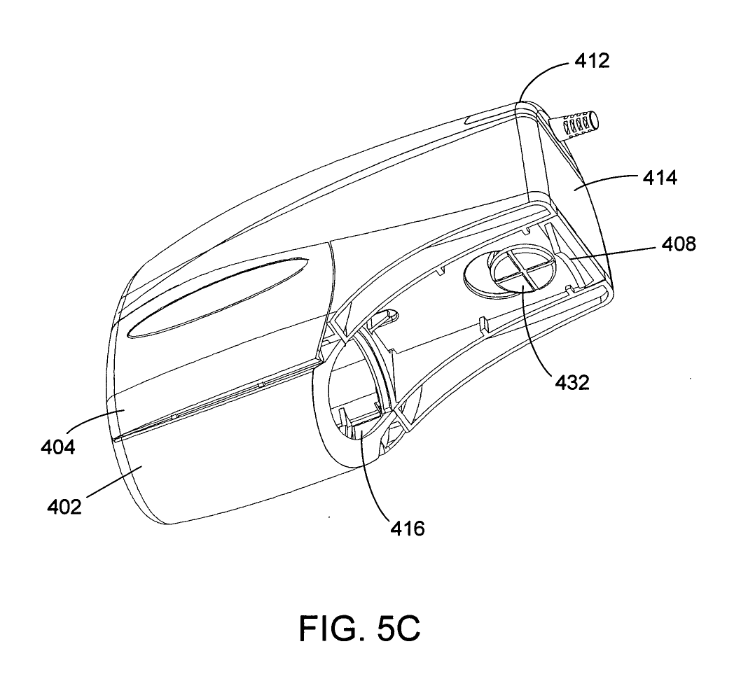

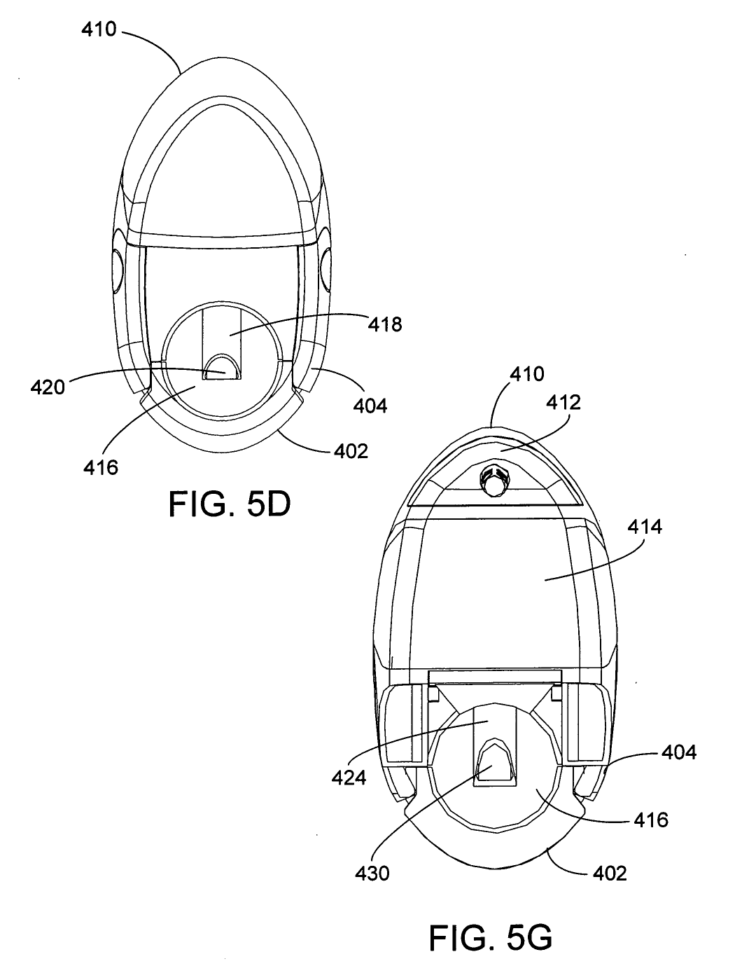

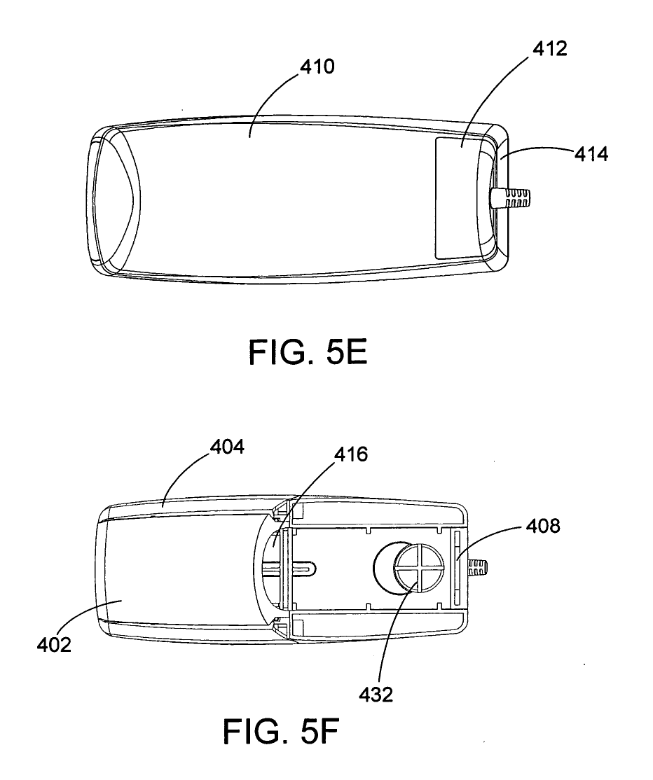

FIG. 5A and FIG. 5B are a front perspective view and a rear perspective view, respectively, of the embodiment of the device shown in FIG. 4A-E, with the corresponding features numbered as in those figures. FIG. 5C is a lower rear perspective view of this embodiment, showing drain plug 432, which allows fluid to be drained from the vessel, e.g., during maintenance procedures. FIG. 5D is a front view of the vessel, FIG. 5E is a top view of the vessel, and FIG. 5F is a bottom view of the vessel. FIG. 5G is a rear view of the vessel, and shows outlet opening 432 in outlet tube 424, by which fluid returns to the conduit.

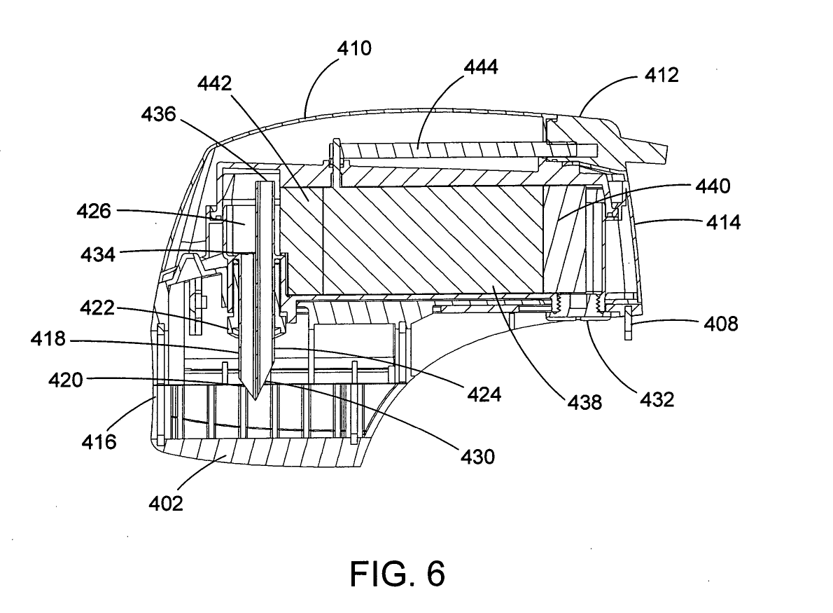

FIG. 6 is a side cross sectional view of the embodiment of FIG. 4 and 5. FIG. 6 shows that fluid entering inlet tube 418 through inlet opening 420 will exit the tube into the lower, proximal portion of chamber 426 through inlet tube exit opening 434. The positioning of exit opening 434 in the lower, proximal portion of chamber 426 allows fluid to flow around outlet tube 424 and back into the remainder of chamber 426, where it comes into contact with the treatment or analysis equipment contained in the fluid processing equipment space. As illustrated in FIG. 6, the fluid first comes into contact with the front part 442 of electrode 438, which consists of a series of longitudinally extending, transversely spaced plates between which and along which the fluid flows toward the rear of the device. These electrode plates are energized by conductor 444, which provides a conductive path between the electrode plates and electric power cable 412. Fluid circulates through the chamber 426, and then passes from the chamber 426 into inlet opening 436 of outlet tube 424, and then through outlet opening 430 of outlet tube 424, and back into the conduit. Outlet tube 424 is adjacent to inlet tube 418 on the distal side, and extends substantially parallel to inlet tube 418.

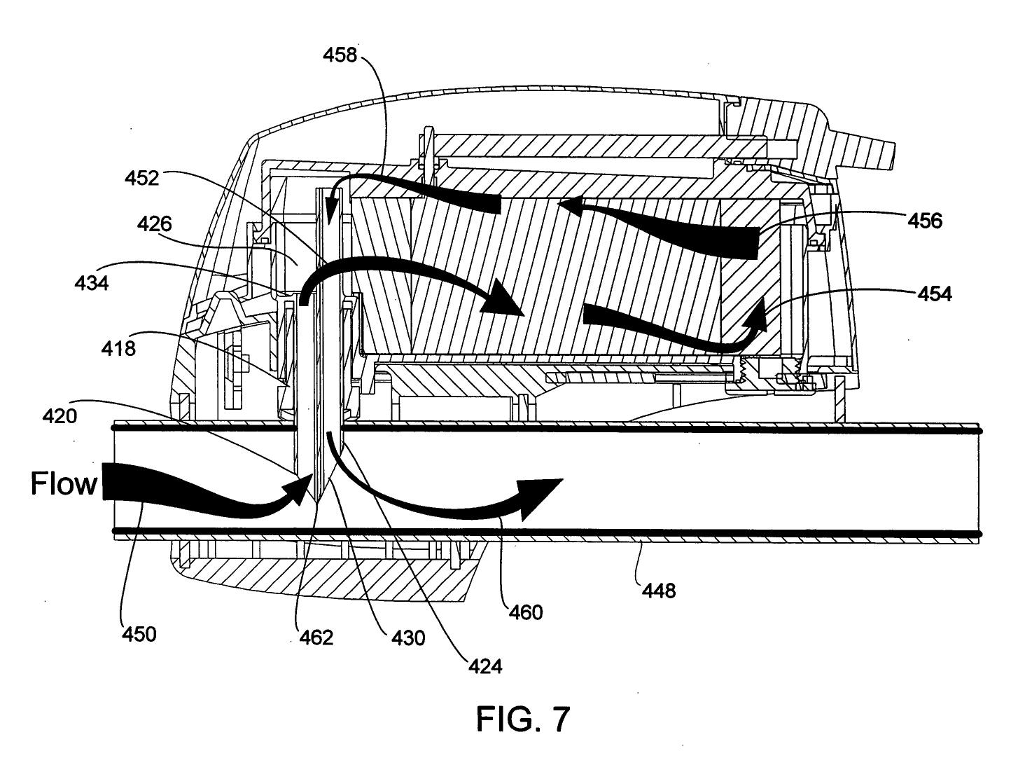

FIG. 7 is a side cross sectional view of the embodiment of the invention shown in FIG. 6, deployed in conjunction with a conduit 448. A portion of the fluid flowing in the conduit is scooped into inlet tube 418 by the forward bevel of inlet opening 420. This portion of fluid is indicated by flow arrow 450. Fluid leaving exit opening 434 of inlet tube 418 and flowing from the lower, proximal region of chamber 426 and into the fluid processing equipment space is indicated by flow arrow 452. Fluid flowing along the lower part of the fluid processing equipment space of chamber 426 and flowing upwardly between the lower distal region and the upper distal region of the chamber 426 is indicated by flow arrow 454. Fluid flowing forward (in the proximal direction) along the upper region of chamber 426 is indicated by flow arrow 456, and fluid flowing from the proximal, upper region of chamber 426 and into inlet opening 436 of outlet tube 424 is indicated by flow arrow 458. Fluid flowing out of rearward beveled outlet opening 430 in outlet tube 424 is indicated by flow arrow 460.

FIG. 6 and FIG. 7 also illustrate the opposed beveling feature of the inlet opening 420 of inlet tube 418 and the outlet opening 430 of outlet tube 424. The forward bevel of inlet opening 420 helps to direct the flow of fluid into the vessel as the forward velocity of the fluid contacts the extended portion of the tube forming opening 420, and is redirected upwardly into the inlet tube 418. The opposed rearward bevel of outlet opening 430 of outlet tube 424 assists in the movement of fluid through the vessel. As a portion of the fluid flowing in the conduit that does not enter inlet opening 420 passes the tubes 418 and 424, its velocity increases as the result of the constriction placed in the conduit by the tubes extending therein. This velocity increase is greatest as the fluid passes point 462. Once past that point, the rearward bevel of outlet opening 430 allows the fluid to rapidly decrease in velocity. This rapid increase and then decrease in velocity of fluid passing the tubes creates a pressure drop between a point just upstream of point 462 and a point just downstream of point 462. The decrease in pressure on the downstream side helps to pull fluid through the vessel by creating a suction through outlet tube 424. This, in turn, exerts suction on the fluid at the upper, proximal region of chamber 426. Combined with a higher pressure on fluid in the lower, proximal region of chamber 426 from fluid entering the inlet tube from the conduit, the flow pattern illustrated in FIG. 7 is created.

The creation of fluid flow patterns such as those obtained in the embodiments of the invention illustrated above provides a significant advantage to the inventive device not previously realized in the art, namely that much, if not all, of the fluid taken into the vessel makes a complete circuit of chamber 426, so that: (a) the fluid comes into thorough contact with equipment located in the fluid processing equipment space of chamber 426, allowing enhanced residence time for the fluid to be analyzed and/or treated by the equipment, and (b) pressure spikes that occur in the fluid passing through the conduit are, in effect, dampened before they reach the equipment contained in chamber 426. This dampening effect is enhanced and assisted by other design features of the invention, namely that only a relatively small portion of the fluid flowing in the conduit is removed and passed through the vessel at any given time, so that the bulk of the fluid experiencing a pressure spike remains in the fluid conduit and does not enter the vessel. In addition, the fluid enters the vessel through a relatively short narrow tube and expands once inside the vessel, dropping its pressure quickly.

As described above, another feature of the invention is that, because of the decreased susceptibility of the vessel to the effects of pressure spikes, the vessel can be fabricated from less pressure-resistant materials, and need not be engineered in the same way as other pressure vessels. For example, the housing 410 of the vessel can be made from plastic, such as engineering and non-engineering thermoplastics, including those of the styrenic polymer family (e.g., acrylonitrile styrene acrylate (ASA), polystyrene (PS), acrylonitrile butadiene styrene (ABS), and homopolymers and copolymers of acrylic acid (AA) and/or methacrylic acid (MAA)), those of the polyester polymer family (e.g., polycarbonate (PC), polybutadiene terephthalate (PBT), copolyesters, and alloys and blends, such as PC/PBT, PC/ASA, etc.), polyolefin thermoplastics, rigid PVC, polyphenylene oxide (PPO) and blends, such as PPO/PS, etc. and can be configured to provide a pleasing aesthetic appearance, rather than engineered as a conventional pressure vessel.

In use, an opening is made in the surface of the fluid flow conduit (typically a water pipe in a water purification system, such as a water filtration line for a pool or spa). The opening is of sufficient size to admit the inlet and outlet tubes, but not so large that it cannot be made effectively leak proof. The housing is secured to the conduit by attachment of a suitable clamp, such as that described above with respect to FIG. 4-7. Fluid measurement or fluid processing equipment is introduced into the chamber either before or after attachment, and the chamber is sealed. Fluid is flowed through the conduit, and thus into and out of the vessel. Any necessary electrical power connections can then be made, e.g., to operate an electrolytic cell.

What is claimed is:

1. A fluid processing vessel, comprising:
a chamber having a proximal region, a distal region, an upper region, and a lower region;
an inlet tube comprising an inlet opening, and an outlet opening disposed in, and in fluid communication with, the proximal lower region of the chamber;
an outlet tube comprising an inlet opening disposed in, and in fluid communication with, the proximal upper region of the chamber, and an outlet opening;
a fluid processing equipment space disposed in the distal region of the chamber.

2. The vessel of claim 1, further comprising a housing enclosing the chamber, wherein the housing is sealably attachable to a fluid flow conduit, and wherein the inlet opening of the inlet tube and the outlet opening of the outlet tube are disposed outside the housing.

3. The vessel of claim 2, wherein the inlet tube is disposed proximally adjacent to the outlet tube.

4. The vessel of claim 3, wherein the inlet opening of the inlet tube comprises a forward bevel.

5. The vessel of claim 4, wherein the outlet opening of the outlet tube comprises a rearward bevel.

6. The vessel of claim 2, further comprising fluid monitoring or fluid processing equipment disposed in the fluid processing equipment space.

7. The vessel of claim 6, wherein the fluid monitoring or fluid processing equipment comprises an electrolytic cell.

8. The vessel of claim 7, wherein the electrolytic cell comprises a plurality of transversely spaced longitudinal electrode plates.

9. The vessel of claim 8, wherein the electrode plates are electrically connected to a power supply cable attachable to the housing.

10. The vessel of claim 6, wherein a fluid treatment media.

11. The vessel of claim 10, wherein the fluid treatment media comprises media for introducing metals or metal ions into the fluid.

12. The vessel of claim 11, wherein the metals or metal ions comprise silver metal or silver ions.

13. The vessel of claim 10, wherein the fluid treatment media comprises an absorbent or adsorbent material.

14. The vessel of claim 10, wherein the fluid treatment media comprises a physicochemically functional species

15. The vessel of claim 6, wherein the fluid processing or fluid monitoring equipment comprises one or more chemical or physical measurement probes.

16. A fluid processing vessel, comprising:
a housing, attachable to a fluid flow conduit;
a clamp, adapted to secure the housing to a fluid flow conduit;
an inlet tube having at one end an inlet opening adapted to be in fluid communication with the fluid flow conduit and having an outlet opening at the other end, separated from the inlet opening by a length of the inlet tube;
a chamber disposed within the housing in fluid communication with the outlet opening of the inlet tube;
an outlet tube disposed distally adjacent and substantially parallel to the inlet tube, having an outlet opening at one end adapted to be in fluid communication with the fluid flow conduit, having an inlet opening at the other end in fluid communication with the chamber, separated from the outlet opening by a length longer than the length of the inlet tube;
wherein the chamber extends distally from the inlet tube and outlet tube.

17. A method of decreasing the effects of sudden pressure increases in a fluid flow conduit on fluid processing or fluid measuring equipment, comprising:
diverting a fluid portion flowing in the fluid flow conduit to flow in a second direction approximately normal to the average direction of fluid flow in the conduit;
withdrawing the fluid portion from the conduit and directing it into a vessel;
diverting the flow direction of the fluid portion to a third direction substantially normal to the second direction;
directing the fluid portion into a chamber of the vessel comprising fluid processing or fluid measuring equipment
diverting the direction of fluid flowing in the chamber to a fourth direction substantially antiparallel to the third direction;
diverting the direction of fluid flowing out of the chamber to a fifth direction substantially antiparallel to the second direction; and
returning the fluid to the fluid flow conduit.

18. The method of claim 17, further comprising contacting fluid with fluid processing or fluid measurement equipment when the fluid is moving in the third direction, the fourth direction, or both.
